(19) United States
(12) Patent Application Publication
(10) Pub. No.: US 2026/0098118 A1
(43) Pub. Date: Apr. 9, 2026

(54) Non-Softening Thermoplastic Polyurethanes

(71) Applicant: Lubrizol Advanced Materials, Inc., Cleveland, OH (US)

(72) Inventors: Nitin Sharma, Mount Laurel, NJ (US); Theodore O. Clifford, Elyria, OH (US); Shawn S. Lankowski, Danvers, MA (US)

(73) Assignee: Lubrizol Advanced Materials, Inc., Cleveland, OH (US)

(21) Appl. No.: 19/114,016

(22) PCT Filed: Sep. 18, 2023
(86) PCT No.: PCT/US2023/033019

§ 371 Date: Mar. 21, 2025

Related U.S. Application Data
(60) Provisional application No. 63/408,990, filed on Sep. 22, 2022.

(51) Int. Cl. C08G 18/10; C08G 18/48

(52) U.S. Cl. CPC C08G 18/10; C08G 18/4854

(57) ABSTRACT

The non-softening thermoplastic polyurethane (TPU) compositions described herein have good rebound resilience while maintaining a good combination of other properties, including hardness, low-temperature flexibility, abrasion resistance, weatherability, low density, and combinations thereof. The degree of softening is independent of the hardness of the TPUs of the disclosed technology. The combination of properties allows the TPU compositions described herein are useful materials for applications where polyamide copolymers (COPA) and/or polyether block amide (PEBA) materials have traditionally been used over TPU.

### TECHNICAL FIELD

In one aspect, the present technology relates to thermoplastic polyurethane (TPU) compositions having non-softening and wet flexibility properties. Such combination of properties makes the TPU compositions described herein useful as materials for applications where polyamide copolymers (COPA) and/or polyether block amide (PEBA) materials have traditionally been used over TPU, especially in medical applications where physical properties, chemical stability, and compatibility in an intracorporeal environment are important.

### BACKGROUND

Thermoplastic polymers, copolymers, and polymer blends have been used extensively in the fabrication of medical devices, including a wide range of long-term and short-term implant devices. Many polymers and polymer blends used in medical devices have specific physical and chemical properties which make them particularly suitable for intracorporeal applications. Preferred chemical, physical and thermomechanical properties depend upon the specific function, the type of tissue, cells or fluids contacting the medical device and the acceptable or desired manufacturing processes. Major considerations in choosing polymers for medical devices include the chemical stability of the polymer, particularly hydrolytic stability, the toxicity of the polymer, and the degree of interaction between tissue or blood and the polymer. Additionally, the polymer or polymer blend should meet all the physical demands relating to the function of the medical device including strength, compliance, stiffness, flexibility and rebound properties.

Certain medical devices, such as catheters, represent a particularly large class of medical devices used for a variety of intracorporeal applications. Typically, catheter bodies are formed of one type of polymer, but more than one type can be incorporated into the catheter body to provide a device which meets the catheter's physical and chemical requirements. Specific types of catheters are widely utilized in a variety of procedures and are physically designed to be maneuvered through tortuous fluid pathways within a body to a preselected site.

To safely maneuver catheters into place, the material used to fabricate the device should have sufficient flexibility and enough bend stiffness to avoid perforating or otherwise harming bodily tissues. On the other hand, excessive softness or pliability of the catheter material leads to difficulty in maneuvering the catheter through a fluid pathway after insertion. The material should have combinations of mechanical properties to allow the device to bend and flex through fluid pathways of the body without causing damage.

While thermoplastic polyurethanes have many mechanical properties which make them attractive for fabrication of medical devices, it is known that TPU compositions having aromatic or cyclic aliphatic isocyanates in the hard segment often exhibit softening when subjected to the aqueous environment found in the body, and thus have not been good candidates for certain applications that require the maintenance of sufficient hardness, flexibility, and maneuverability in these environments. Thus, COPA and/or PEBA materials have often been used over TPU for such applications.

Accordingly, there is an ongoing need for non-softening TPU compositions that can deliver high rigidity, elasticity, rebound resilience and flexibility, or any combination thereof, for intracorporeal implantation into mammalian bodily environments.

### SUMMARY OF THE DISCLOSED TECHNOLOGY

In accordance with one aspect of the present technology, there is provided non-softening thermoplastic polyurethane (TPU) compositions that demonstrate good mechanical properties, such as flexibility, maneuverability, and rigidity, at least comparable to PEBA and COPA materials.

In one aspect, the disclosed technology provides a thermoplastic polyurethane (TPU) composition prepared from a reaction mixture comprising:
(a) at least one isocyanate terminated low free polyurethane prepolymer (“prepolymer” for brevity) composition prepared from the reaction of at least one polyisocyanate component (i) and at least one polyol component (ii), wherein said low free polyurethane prepolymer composition comprises more than about 0 wt. % to about 1 wt. % or less, or from about 0.05 or less wt. % to about 0.75 wt. % or less, or from about 0.1 wt. % or less to about 0.5 wt. % or less of residual polyisocyanate component;
(b) at least one linear aliphatic polyisocyanate, wherein the weight ratio of said at least one aliphatic polyisocyanate to said low free polyurethane prepolymer ranges from about 10:1 to about 1:10;
(c) at least one optional polyol component ranging from 0 wt. to about 80 wt. % of the total weight of the thermoplastic polyurethane; and
(d) a chain extender component comprising (iii) a first chain extender selected from at least one linear, unsubstituted alkane diol containing from about 2 to about 20 carbon atoms, and (iv) a second chain extender selected from at least one cycloaliphatic diol, or at least one aliphatic branched short chain diol, or at least one dianhydrohexitol diol, wherein the weight ratio of said first chain extender to said second chain extender ranges from about 1:19 to about 19:1.

In one aspect, the disclosed technology provides a thermoplastic polyurethane composition preprepared from a reaction mixture comprising:
(a) at least one isocyanate terminated low free polyurethane prepolymer (“prepolymer” for brevity) composition prepared from the reaction of at least one aliphatic diisocyanate component (i) and at least one polyether polyol component (ii), wherein said low free polyurethane prepolymer composition comprises more than about 0 wt. % to about 1 wt. % or less, or from about 0.05 or less wt. % to about 0.75 wt. % or less, or from about 0.1 wt. % or less to about 0.5 wt. % or less of residual polyisocyanate component;
(b) at least one linear aliphatic polyisocyanate, wherein the weight ratio of said at least one linear aliphatic polyisocyanate to said low free polyurethane prepolymer ranges from about 10:1 to about 1:10;
(c) at least one optional polyol component ranging from 0 wt. to about 80 wt. % of the total weight of the thermoplastic polyurethane; and
(d) a chain extender component comprising (iii) a first chain extender selected from at least one linear, unsubstituted alkane diol containing from about 2 to about 20 carbon atoms, and (iv) a second chain extender selected from at least one cycloaliphatic diol, wherein the weight ratio of said first chain extender to said second chain extender ranges from about 1:19 to about 19:1.

In one aspect, the disclosed technology provides a thermoplastic polyurethane composition preprepared from a reaction mixture comprising:
(a) at least one isocyanate terminated low free polyurethane prepolymer composition is prepared by the reaction of (i) 1,6-hexamethylene diisocyanate with (ii) polytetramethylene ether glycol (PTMEG), wherein said low free polyurethane prepolymer composition comprises more than about 0 wt. % to about 1 wt. % or less, or from about 0.05 or less wt. % to about 0.75 wt. % or less, or from about 0.1 wt. % or less to about 0.5 wt. % or less of residual polyisocyanate component;
(b) at least one linear aliphatic polyisocyanate selected from 1,6-hexamethylene diisocyanate, wherein the weight ratio of said 1,6-hexamethylene diisocyanate to said low free polyurethane prepolymer ranges from about 10:1 to about 1:10;
(c) at least one optional polyol component ranging from 0 wt. to about 80 wt. % of the total weight of the thermoplastic polyurethane; and
(d) a chain extender component comprising (iii) a first chain extender comprising 1,4-butane diol, and (iv) a second chain extender comprising 1,4-cyclohexanedimethanol, wherein the weight ratio of said first chain extender to said second chain extender ranges from about 1:19 to about 19:1.

In one aspect, the non-softening TPU compositions of the present technology are useful as materials for applications where polyamide copolymers (COPA) and/or polyether block amide (PEBA) materials have traditionally been used, especially in medical applications where physical properties, chemical stability, and compatibility in an intracorporeal environment are important.

In one aspect, the disclosed technology provides non-softening TPU compositions having one or more of the following properties:
a) Shore D hardness, as measured by ASTM D2240, from about 20 to about 75;
b) a dry flexural modulus, as measured by ASTM D790, from about 4,000 to about 90,000 psi;
c) a wet flexural modulus, as measured by ASTM D790, from about 3,000 to about 50,000 psi;
d) an elongation at break, as measured by ASTM D412 from about 300 to about 750 percent;
e) a tensile strength, as measured by ASTM D412, of from about 5,000 to about 10,000 psi; and
f) a rebound recovery as measured by ASTM D2632 of from about 40 to about 65 percent.

In one aspect, the TPU compositions of the disclosed technology provide a softening % of 20 or less, while maintaining enhanced dry flexural modulus, wet flexural modulus, tensile strength and/or rebound resilience at comparable Shore D durometer values.

In one aspect, the TPU compositions of the disclosed technology further comprise pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, radiopacifiers, antimicrobials, and mixtures thereof.

In one aspect, the non-softening TPU compositions of the disclosed technology are suitable for the manufacture of a medical article suitable for intracorporeal implantation into a mammalian body.

In one aspect, non-limiting examples of medical articles made from the TPU compositions of the disclosed technology include a pacemaker head, an angiography catheter, an angioplasty catheter, an epidural catheter, a thermal dilution catheter, a urology catheter, a catheter connector, medical tubing, intravenous tubing, cartilage replacement, or a joint replacement.

The disclosed technology further provides a process for preparing the non-softening thermoplastic polyurethane compositions disclosed herein, the process comprising the step of: (I) reacting a mixture comprising:
(a) at least one isocyanate terminated low free polyurethane prepolymer composition prepared from the reaction of at least one polyisocyanate component (i) and at least one polyol component (ii), wherein said low free polyurethane prepolymer composition comprises more than about 0 wt. % to about 1 wt. % of residual polyisocyanate component;
(b) at least one linear aliphatic polyisocyanate, wherein the weight ratio of said at least one aliphatic polyisocyanate to said low free polyurethane prepolymer ranges from about 10:1 to about 1:10;
(c) at least one polyol component ranging from 0 wt. to about 80 wt. % of the total weight of the thermoplastic polyurethane; and
(d) a chain extender component comprising (iii) a first chain extender selected from at least one linear, unsubstituted alkane diol containing from about 2 to about 20 carbon atoms, and (iv) a second chain extender selected from at least one cycloaliphatic diol, or at least one aliphatic branched short chain diol, or at least one dianhydrohexitol diol, wherein the weight ratio of said first chain extender to said second chain extender ranges from about 1:19 to about 19:1.

The disclosed technology further provides a process further comprising the step of: (II) mixing the non-softening thermoplastic polyurethane composition prepared in step (I) with one or more additional additives selected from pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, radiopacifiers, antimicrobials, and mixtures thereof.

### BRIEF DESCRIPTION OF THE DRAWINGS

FIG. 1 represents a plot of Shore D durometer values (x-axis) versus softening percent (y-axis) for selected TPU compositions of the disclosed technology.

FIG. 2 represents a plot of Shore D durometer hardness values (x-axis) versus softening percent (y-axis) for selected TPU compositions of the disclosed technology versus the benchmark polymer and comparative TPU samples.

### DETAILED DESCRIPTION

Various aspects, features and embodiments of the disclosed technology will be described below by way of non-limiting illustration.

The non-softening TPU compositions of the disclosed technology may suitably comprise, consist of, or consist essentially of the components, elements, and process delineations described herein. The technology illustratively disclosed herein suitably may be practiced in the absence of any element which is not specifically disclosed herein.

Unless otherwise specified, in all aspects of the disclosed technology all percentages are calculated by the weight of the total composition. All ratios are expressed as weight ratios. All numerical ranges for amounts are inclusive and combinable unless otherwise specified.

While overlapping weight ranges for the various components and ingredients that can be contained in the disclosed compositions have been expressed for selected embodiments and aspects of the disclosed technology, the amount of each component in the disclosed compositions is selected from its disclosed range such that the sum of all components or ingredients in the composition will total 100 weight percent. The amounts employed will vary with the purpose and character of the desired product and can be readily determined by one skilled in the art.

By the term “non-softening” (expressed as softening %) is meant that the TPU compositions of the disclosed technology are resistant to softening when exposed to intracorporeal environments over time. Softening % is calculated from the following formula (see methodology in Examples 7 to 12):

Softening %=[(Flexural Modulusdry-Flexural Moduluswet)×100/Flexural Modulus_{dry}

By “low free” is meant that the polyurethane prepolymer (a) of the disclosed technology comprises more than about 0 wt. % to about 1 wt. % or less, or from about 0.05 or less wt. % to about 0.75 wt. % or less, or from about 0.1 wt. % or less to about 0.5 wt. % or less of unreacted (residual) polyisocyanate employed to prepare the prepolymer.

The disclosed technology provides a thermoplastic polyurethane (TPU) composition prepared from a reaction mixture comprising:
(a) at least one isocyanate terminated low free polyurethane prepolymer composition prepared from the reaction of at least one polyisocyanate component (i) and at least one polyol component (ii), wherein said low free polyurethane prepolymer composition comprises more than about 0 wt. % to about 1 wt. % or less, or from about 0.05 or less wt. % to about 0.75 wt. % or less, or from about 0.1 wt. % or less to about 0.5 wt. % or less of residual polyisocyanate (e.g., diisocyanate) component, based on the total weight of the low free polyurethane prepolymer, wherein the amount of said low free polyurethane prepolymer ranges from about 1 to about 80 wt. %, or from about 15 to about 50 wt. %, based on the total weight of said thermoplastic polyurethane;
(b) at least one linear aliphatic polyisocyanate, wherein the weight ratio of said at least one aliphatic polyisocyanate to said low free polyurethane prepolymer ranges from about 10:1 to about 1:10, or from about 1:1 to about 1:2;
(c) at least one polyol component ranging from 0 wt. %, or from about 5 wt. % to about 80 wt. % of the total weight of the thermoplastic polyurethane; and
(d) a chain extender component comprising (iii) a first chain extender selected from at least one linear, unsubstituted alkane diol containing from about 2 to about 20 carbon atoms, and (iv) a second chain extender selected from at least one cycloaliphatic diol, or at least one aliphatic branched short chain diol, or at least one dianhydrohexitol diol, wherein the weight ratio of said first chain extender to said second chain extender ranges from about 1:19 to about 19:1, or from about 1:1 to about 10:1, or from about 2:1 to about 5:1.

### Isocyanate Terminated Low Free Polyurethane Prepolymer (Component (a))

The at least one isocyanate terminated low free polyurethane prepolymer composition (polyurethane prepolymer) that is employed in the preparation of the non-softening TPU compositions of the disclosed technology is prepared from the reaction of a stoichiometric excess of at least one polyisocyanate component (i) and at least one polyol component (ii) containing at least two hydroxyl groups.

In one aspect, the at least one isocyanate terminated low free polyurethane prepolymer composition is the reaction product of a stoichiometric excess of a diisocyanate component and a diol component.

The polyurethane prepolymer reaction product comprises oligomers and so called “perfect” prepolymers. The requisite high oligomer content of the prepolymer composition is greater than 20 wt. % or, reciprocally, it can be expressed in terms of its content of a 2:1 stoichiometric adduct of diisocyanate and polyol which should be less than 75 wt. %, based on the total weight of the prepolymer composition. 2:1 stoichiometric adducts of diisocyanate and at least one polyol (“perfect prepolymers”) as well as processes for preparing them, are widely known and described in the art, for example, in EP 0 288 823 A1, EP 0 370 408 A1, EP 0 370 392 A1, EP 0 827 995 A1, EP 1 237 967 A1, EP 1 237 971 A1, EP 1 249 460 A1, EP 1 253 159 A1, EP 1 499 653 A1 and EP 1 553 118 A1, which are hereby incorporated by reference.

A 2:1 stoichiometric adduct of diisocyanate and at least one polyol of the disclosed technology, is the stoichiometric end capping product of one polyol molecule (B) with two diisocyanate molecules (A). The stoichiometric proportions for the diisocyanate and polyol in the reaction products are 2:1 in the case of diols (difunctional polyol (B)). The perfect prepolymer is essentially an adduct containing only one molecule of the polyol (B) in each prepolymer molecule A:B:A (or A2B).

Oligomers of prepolymer composition (a) are, for a difunctional polyol (B), any species with a composition greater than the perfect 2:1 molecular ratio (A:B:A, i.e., a diurethane), for example 3:2 (A:B:A:B:A, i.e., a triurethane) or 4:3 (A:B:A:B:A:B:A, i.e., a tetraurethane).

In one aspect, the prepolymer composition (1) comprises less than 75 wt. %, or less than 73 wt. %, or less than 70 wt. %, of a 2:1 stoichiometric adduct of a diisocyanate and a polyol, based on the total weight of polyurethane prepolymer, and (2) comprises more than 0 wt. % and less than 1.0 wt. % unreacted, and thus free, diisocyanate monomer. In one aspect, the disclosed technology requires that the diisocyanate prepolymer reaction product (1) comprises more than 30 wt. % of a 2:1 stoichiometric adduct of diisocyanate and at least one polyol and less than 75 wt. %, or less than 73 wt. %, or less than 70 wt. % of a 2:1 stoichiometric adduct of diisocyanate and at least one polyol, and (2) contains more than 0 wt. % and less than 0.1 wt. % unreacted diisocyanate monomer.

In one aspect, the polyurethane prepolymer reaction product contains free prepolymer NCO functionality ranging from 0.2 to 15 wt. %, or from about 0.5 to about 8 wt. %, or from about 5 to about 7 wt. %. Free NCO content is typically determined in percent by weight according to ASTM D1638-70. In one aspect, the polyurethane prepolymer compositions of the disclosed technology contain free prepolymer NCO groups ranging from about 0.2 to about 15 wt. %, or from about 0.5 to about 8 wt. %, or from about 5 to about 7 wt. %, and more than 0 wt. % to less than 1.0 wt. % unreacted (residual) diisocyanate monomer, based on the weight of the polyurethane prepolymer. In one aspect, the unreacted (residual) diisocyanate monomer is less than about 0.5 wt. %, or less than about 0.1 wt. %, based on the weight of the polyurethane prepolymer.

In one aspect of the present technology, the polyurethane prepolymer comprises at least about 30 wt. % of a 2:1 stoichiometric adduct of diisocyanate and at least one polyol and less than about 75 wt. % of a 2:1 stoichiometric adduct of diisocyanate and at least one polyol, or less than about 75 wt. % of a 2:1 stoichiometric adduct of diisocyanate and at least one polyol, or less than about 70 wt. % of a 2:1 stoichiometric adduct of diisocyanate and at least one polyol, or less than about 65 wt. % of a 2:1 stoichiometric adduct of diisocyanate and at least one polyol, or reciprocally at least 20 wt. % oligomers, preferably at least 25 wt. % oligomers, more preferably at least 30 wt. % oligomers and even more preferably at least 35 wt. % oligomers, based on the total weight of prepolymer.

### Polyurethane Prepolymer Polyisocyanate (Component (i))

The polyisocyanate component of the disclosed technology is not particularly limited and includes, aromatic, aliphatic (cycloaliphatic and liner aliphatic) polyisocyanates, and mixtures thereof. In one aspect, the polyisocyanate component used to prepare the prepolymer of the present technology is a diisocyanate. Non-limiting examples of suitable diisocyanates are include aromatic diisocyanates such as 4,4′-methylene bis-(phenyl isocyanate) (MDI); m-xylylene diisocyanate (XDI), phenylene-1,4-diisocyanate (PPDI), 3,3′-dimethyl-4,4′-biphenylene diisocyanate (TODI), diphenylmethane-3,3′-dimethoxy-4,4′-diisocyanate, toluene diisocyanate (TDI), and naphthalene-1,5-diisocyanate; cycloaliphatic diisocyanates such as isophorone diisocyanate (IPDI), dicyclohexylmethane-4,4′-diisocyanate (H12MDI), 1,4-cyclohexyl diisocyanate (CHDI), and linear aliphatic diisocyanates such as 1,6-hexamethylene diisocyanate (HDI), and decane-1,10-diisocyanate; and mixtures thereof.

Polyurethane Prepolymer Polyol (Component (ii))

The polyurethane prepolymers described herein are made using a polyol component. Polyols include polyester polyols, polyether polyols, polycarbonate polyols, polysiloxane polyols, alkoxylated polysiloxane polyols, polybutadiene polyols, and combinations thereof.

In one aspect, the polyols are selected from a hydroxyl terminated diol, which include one or more hydroxyl terminated polyesters, one or more hydroxyl terminated polyethers, one or more hydroxyl terminated polycarbonates, one or more hydroxyl terminated polysiloxanes, one or more hydroxyl terminated polybutadienes, and mixtures thereof.

Suitable hydroxyl terminated polyester intermediates include linear polyesters having a number average molecular weight (Mn) of from about 500 to about 10,000, from about 700 to about 5,000, or from about 700 to about 4,000, and generally have an acid number less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. In one aspect, mole ratios of more than one mole of glycol to acid are employed to obtain linear chains having a preponderance of terminal hydroxyl groups. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

In one aspect, the polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In one aspect, the polycaprolactone polyester polyols are linear polyester diols derived from caprolactone monomers.

Useful examples include CAPA™ 2202A, a 2,000 number average molecular weight (Mn) linear polyester diol, and CAPA™ 2302A, a 3,000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3,000.

Suitable hydroxyl terminated polyether intermediates include polyether polyols derived from a diol or polyol having a total of from 2 to 15 carbon atoms. In some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHFR B, a block copolymer, and PolyTHFR R, a random copolymer. The various polyether intermediates generally have a number average molecular weight (Mn) as determined by assay of the terminal functional groups which is an average molecular weight of about 300 or more, or from about 500 or more, or from about 700 or more, or from about 1,000 or more, or from about 14,50, or from about 2,500 or more or from about 3,000 or more, or from about 5,000 or more, or from about 8,000 or more, or from about 10,000 or more. In some embodiments, the polyether intermediate includes a blend of two or more different molecular weight polyethers, such as, for example, a blend of 300 Mn and 8,000 Mn PEG or a blend of 300 Mn, 1450 Mn and 8,000 Mn PEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include α-ω-hydroxyl or hydroxyalkyl terminated diols. Examples include poly(dimethysiloxane) terminated with a hydroxyl or hydroxyalkyl end groups. In one aspect, the polysiloxane polyol is a hydroxyl terminated polydimethylsiloxane. In one aspect, the polysiloxane polyol is selected from a hydroxymethyl, hydroxyethyl, or hydroxypropyl terminated polydimethylsiloxane. In one aspect, the polysiloxane polyols have a number-average molecular weight in the range from about 300 to about 5,000, or from about 400 to about 3,000.

Polysiloxane polyols can be obtained by the dehydrogenation reaction between a polysiloxane hydride and an aliphatic polyhydric alcohol or a polyoxyalkylene alcohol to introduce the alcoholic hydroxy groups onto the polysiloxane backbone.

In one aspect, the polysiloxane polyol is selected from one or more compounds represented by the following formula:

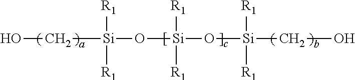

wherein each of R₁ is independently selected from C₁ to C₄ alkyl, benzyl, and phenyl; a and b each independently represent an integer from 0 to 8, or 1 to 8; and c represents an integer from 3 to 50. In one aspect, each of R₁ is a methyl group.

Suitable polysiloxane polyols are commercially available from Dow Chemical, Gelest, and Sigma-Aldrich.

Alkoxylated polysiloxane polyols, copolymers of dimethylsiloxane (dimethicone) modified with alkylene oxide units. The alkylene oxide units can be arranged as random or block copolymers. A generally useful class of dimethicone polyols are block copolymers having terminal and/or pendent blocks of polydimethylsiloxane and blocks of polyalkylene oxide, such as blocks of polyethylene oxide, polypropylene oxide, or both.

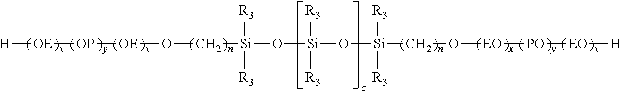

wherein each of R₃ is independently selected from C₁ to C₄ alkyl, benzyl, and phenyl; OE and EO represent an ethylene oxide residue (e.g., —CH₂CH₂O—); OP and PO represent a propylene oxide residue (e.g., —CH₂CH₂CH₂O— and/or —CH₂CH(CH₃)O—); x independently represents an integer ranging from about 0 to about 200, or from about 1 to about 100, or from about 2 to about 50, or from about 3 to about 25, or from about 5 to about 20, or from about 8 to about 15; y independently represents an integer ranging from about 0 to about 200, or from about 1 to about 100, or from about 2 to about 50, or from about 3 to about 25, or from about 5 to about 20, or from about 8 to about 15, subject to the proviso that x and y cannot all be 0 at the same time; z represents an integer ranging from about 1 to about 1000, or from about 5 to about 800, or from about 10 to about 500, or from about 15 to about 200, or from about 25 to 100; and n independently represents an integer ranging from about 1 to about 4. The OE, EO, OP, and PO residues can be arranged in random, nonrandom, or in block sequences.

In one aspect, each R₃ group is methyl; x independently represents an integer ranging from about 1 to about 100, or from about 2 to about 50, or from about 3 to about 25, or from about 5 to about 20; y is 0; z represents an integer ranging from about 1 to about 100; and n represents an integer ranging from about 1 to about 4.

Alkoxylated polysiloxane polyols are disclosed in U.S. Pat. No. 5,180,843 which is incorporated herein by reference. Alkoxylated polysiloxane polyols are commercially available from Lubrizol Advanced Materials, Inc. under the Silsense trade name.

Suitable polybutadiene polyols can be selected from linear or branched hydroxyl-terminated, optionally hydrogenated, polybutadiene diols.

Among the hydroxyl-terminated polybutadiene diols that are useful for preparing the isocyanate terminated low free prepolymers of the disclosed technology are those possessing a number average molecular weight (Mn) of from about 500 to about 10,000, or from about 800 to about 5,000, a primary hydroxyl group content of from about 0.1 to about 2.0 meq/g, or from about 0.3 to about 1.8 meq/g, a degree of hydrogenation of from 0 up to 100 percent of the olefinic sites present and an average content of copolymerized additional monomer(s) of from 0 up to about 50 wt. %.

The hydroxyl-terminated butadiene diols average more than one predominantly primary hydroxyl group per molecule, e.g., averaging from about 1.7 to about 2.4 primary hydroxyl groups per molecule. In one aspect, the hydroxyl-terminated polybutadienes possess an average of at least about 2 hydroxyl groups, the hydroxyl groups are predominantly situated in terminal allylic positions on the polybutadiene main chain, i.e., generally longest, hydrocarbon chain of the molecule. By “allylic” configuration is meant that the alpha-allylic grouping of allylic alcohol, i.e., the terminal hydroxyl groups of the polymer, are bonded to carbon atoms adjacent to double bonded carbon atoms.

The hydroxyl-terminated polybutadienes can also incorporate one or more other copolymerizable monomers. The total amount of copolymerized monomer will not exceed, on average, 50 wt. % of the hydroxyl-terminated polybutadiene copolymer. Included among the copolymerizable monomers are monoolefins and dienes such as ethylene, propylene, 1-butene, isoprene, chloroprene, 2,3-methyl-1,3-butadiene, 1,4-pentadiene, etc., and ethylenically unsaturated monomers such as acrylonitrile, methacrylonitrile, methylstyrene, methyl acrylate, methyl methacrylate, vinyl acetate, and the like.

In one aspect of the disclosed technology, the isocyanate terminated low free polyurethane prepolymer is end-capped by isocyanatohexyl groups.

In one aspect of the disclosed technology, the isocyanate terminated low free polyurethane prepolymer is prepared by the reaction of 1,6-hexmethylene diisocyanate and a polyether polyol.

In one aspect of the disclosed technology, the isocyanate terminated low free polyurethane prepolymer is prepared by the reaction of 1,6-hexmethylene diisocyanate and tetrahydrofuran.

### Prepolymer Preparation

Methods for synthesizing isocyanate terminated polyurethane prepolymers are well-known in the art. Generally, the isocyanate terminated low free polyurethane prepolymer of the disclosed technology is prepared by the reaction of an excess of the at least one polyisocyanate (component (i)) with the at least one polyol (component (ii)). In one aspect, the at least one polyisocyanate is selected from a diisocyanate, and the at least one polyol is selected from a diol. As mentioned previously, a 2:1 ratio of the at least one diisocyanate to the at least one diol is employed in the reaction mixture. The stoichiometric excess of diisocyanate ensures that the diol is fully end-capped by isocyanate moieties. The reaction mixture comprising the at least one polyisocyanate (e.g., diisocyanate) and the at least one polyol (e.g., diol) is heated at a temperature range from about 50 to about 150° C., or from about 60 to about 100° C. for 10 min. to 24 hrs., or 2 to 6 hrs.

The formation of the isocyanate terminated prepolymer of the disclosed technology may be achieved without the use of a catalyst. However, a catalyst is optionally employed in some instances depending on the application for the end-products fabricated from the polyurethanes prepared with the isocyanate terminated low free prepolymer. In one aspect, the reaction to form the prepolymer is not catalyzed. The use of a catalyst may lead to residual catalyst in the prepolymer reaction product which may result in toxicity problems for medical applications for TPUs utilizing such prepolymers.

The isocyanate terminated polyurethane prepolymer of the disclosed technology is a low free residual monomer polyurethane prepolymer, meaning that the polyurethane prepolymer compositions contain 1.0 wt. % or less of free residual polyisocyanate (e.g., diisocyanate) monomers, based on the total weight of polyurethane prepolymer. The unreacted diisocyanate residual monomer in the prepolymer reaction product is removed to a concentration ranging from more than 0 wt. % to about 1.0 wt. % or less, or from about 0.05 to about 0.75 or less, or from about 0.1 to about 0.5 wt. % or less, based on the total weight of the polyurethane prepolymer.

The residual polyisocyanate monomer can be removed from the polyurethane prepolymer by conventional means known in the art. For example, methods for removing the residual isocyanate containing monomer from polyurethane prepolymer compositions include but are not limited to wiped film evaporation, solvent aided distillation or co-distillation, molecular sieves, and solvent extraction. In one aspect, distillation under reduced pressure may be employed, such as, for example, thin film or agitated film evaporation under vacuum.

The amount of free diisocyanate residual monomers in the prepolymer composition can be determined by conventional means known in the art such as by high performance liquid chromatography (HPLC) methodology.

In one aspect, the prepolymers of the disclosed technology and their preparation are disclosed in International Publication No. WO 2021/051039, which is hereby incorporated by reference.

### Thermoplastic Polyurethane

The TPU compositions of the disclosed technology are prepared by reacting (a) a mixture of the at least one isocyanate terminated low free polyurethane prepolymer described above; (b) at least one linear aliphatic polyisocyanate, wherein the weight ratio of said at least one aliphatic polyisocyanate to said isocyanate terminated low free polyurethane prepolymer ranges from about 10:1 to about 1:10, or from about 1:1 to about 1:2; (c) at least one polyol component ranging from 0 wt. %, or from about 5 wt. % to about 80 wt. % of the total weight of the thermoplastic polyurethane; and (d) a chain extender component comprising (iii) a first chain extender selected from at least one linear, unsubstituted alkane diol containing from about 2 to about 20 carbon atoms, and (iv) a second chain extender selected from at least one cycloaliphatic diol, or at least one aliphatic branched short chain diol, or at least one dianhydrohexitol diol, wherein the weight ratio of said first chain extender to said second chain extender ranges from about 1:19 to about 19:1, or from about 1:1 to about 10:1, or from about 2:1 to about 5:1.

The polyurethanes of the disclosed technology can be prepared using a variety of techniques known in the art. In one aspect, a preformed isocyanate terminated low free polyurethane prepolymer (a) is reacted with the at least one linear aliphatic polyisocyanate (b), optional polyol (c), and the chain extender component (d) comprising a first chain extender and a second chain extender as described herein. Optional catalyst and other optional additive components can be added to the reaction mixture.

The preformed isocyanate terminated low free polyurethane prepolymer (a) can be prepared as described above or can be obtained commercially. In one aspect, an isocyanate terminated low free polyurethane prepolymer is commercially available from Lanxess AG under the trade name Adiprene™ LFH E1192 which is a reaction product of hexamethylene diisocyanate (HDI) and a polyether polyol having a low free HDI content (<0.1 wt. %).

In one aspect, the preformed isocyanate terminated low free polyurethane prepolymer (a), linear aliphatic polyisocyanate (b), optional polyol (c), chain extender components (d) and other optional additive components, upon mixing, are maintained at a temperature of at least about 90° C. for at least about 10 minutes, or at least about 110° C., or at least about 120° C., or at least about 130° C., or at least about 140° C., for at least about 3 seconds to two hours or more, or at least about 10 minutes, or at least about 20 minutes, or at least about 30 minutes, or at least about an hour. In some non-limiting aspects, upon mixing, the components are maintained at a temperature of at least about 100° C., or at least about 105° C., or at least about 110° C., or at least from about 125 to about 220° C. for at least about 10 minutes, at least about 20 minutes, or at least about an hour.

In one aspect, the isocyanate terminated low free polyurethane prepolymer (a) is formed as described above, followed by introducing (with mixing) the linear aliphatic polyisocyanate (b), optional polyol (c), chain extender components (d) and other optional additive components to the reaction medium under the temperature ranges and times mentioned in the paragraph immediately above.

In one aspect, a process to produce the TPU of the disclosed technology is a process referred to as the one-shot polymerization process. In the one-shot polymerization process, which generally occurs in situ, a simultaneous reaction occurs between reaction components (a), (b), optionally (c), and (d).

In one aspect, the TPU forming components of the disclosed technology are melt polymerized in a suitable mixer, such as an internal mixer (e.g., Banbury mixer), or in an extruder (e.g., twin screw extruder). The reaction is generally initiated at a temperature of from about 90° C. to about 200° C. In as much as the reaction is exothermic, the reaction temperature generally increases to about 220° C. to 250° C. If the reaction is conducted in a reaction extruder, the TPU polymer will exit the extruder and will typically be pelletized. Alternatively, if the reaction is conducted in a mixer or vessel, the TPU reaction product is poured into a block mold to cure. Optionally, the TPU pellets or blocks can be stored at elevated temperature to continue the reaction to fully react all reaction components. Molded TPU blocks are typically processed into crumb form. The TPU pellet and crumb product can be further melt processed (with optional additives) on an extruder and molded into final product form.

Alternatively, the TPU reaction components (with optional additives) can be polymerized in an extruder as previously described and directly extruded or molded into the desired final product.

### Optional Additives

One or more additional additives selected from pigments, including but not limited to, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, antimicrobials, and mixtures thereof can be blended into the TPU compositions of the disclosed technology.

In one aspect, the resulting TPU has the following properties:
a) Shore D hardness, as measured by ASTM D2240, from about 20 to about 75;
b) a dry flexural modulus, as measured by ASTM D790, from about 4,000 to about 90,000 psi;
c) a wet flexural modulus, as measured by ASTM D790, from about 3,000 to about 50,000 psi;
d) an elongation at break, as measured by ASTM D412 from about 300 to about 750 percent;
e) a tensile strength, as measured by ASTM D412, of from about 5,000 to about 10,000 psi;
f) a rebound recovery as measured by ASTM D2632 of from about 40 to about 65 percent.

### Polyisocyanate (b)

In one aspect, the at least one linear aliphatic polyisocyanate (b) is selected from a C₁ to C₁₂ linear aliphatic diisocyanate. Exemplary C₁ to C₁₂ linear aliphatic diisocyanates include but are not limited to ethylene diisocyanate, 1,3-propane diisocyanate, 1,4-butane diisocyanate, 1,5-pentane diisocyanate, 1,6-hexane diisocyanate (hexamethylene diisocyanate or HDI), 1,8-octane diisocyanate, and 1,12-dodecane diisocyanate. The linear aliphatic diisocyanate can be used individually or a combination of 2 or more. More particularly, the one linear aliphatic polyisocyanate can be HDI.

### Polyol (c)

In the preparation of the TPU of the disclosed technology, the use of polyol (c) is optional. The polyol can be employed in the reaction mixture in an amount ranging from about 0 to about 80 wt. %, based on the total weight of the polyurethane. In one aspect, if employed in the reaction mixture, polyol (c) can be selected from any polyol known in the preparation of TPUs. In one aspect, polyol component (c) is selected from the diol components described above for use in the preparation of the isocyanate terminated low free polyurethane prepolymer described above, e.g., polyether polyols, polyester polyols, polycarbonate polyols, polysiloxane polyols, polybutadiene polyols, and mixtures thereof.

In one aspect, polyol (c) is selected from poly(ethylene oxide), polyethylene glycol, poly(propylene oxide), polypropylene glycol, polytetramethylene ether glycol, and mixtures thereof, each of which have been previously described hereinabove under prepolymer polyol component (ii), the disclosure of which is herein incorporated by reference.

### Chain Extender (d)

In the preparation of the TPU compositions of the disclosed technology, chain extender (d) comprises (iii) a first chain extender selected from at least one linear, unsubstituted alkane diol containing from about 2 to about 20 carbon atoms, and (iv) a second chain extender selected from at least one cycloaliphatic diol, or at least one aliphatic branched short chain diol, or at least one dianhydrohexitol diol. The weight ratio of said first chain extender to said second chain extender ranges from about 1:19 to about 19:1, or from about 1:1 to about 10:1, or from about 2:1 to about 5:1.

In one aspect, the weight ratio of the polyol component to total chain extender component (first and second) ranges from about 0 to about 20:1.

In one aspect, the total chain extender component (first and second) comprises from about 2 wt. % to 35 wt. % of the total weight of the polyurethane composition.

In one aspect, first chain extender (iii) is selected from at least one linear, unsubstituted alkane diol containing from about 2 to about 20 carbon atoms. Exemplary first chain extenders include ethylene glycol, diethylene glycol, propylene glycol, 1,3-propane diol, dipropylene glycol, 1,3-butanediol, 1,4-butanediol (BDO), 1,5-pentanediol, 1,6-hexanediol (HDO), 1,7-heptanediol, 1,9-nonanediol, 1,11-undecanediol, 1,12-dodecanediol, and mixtures thereof.

In one aspect, the second chain extender is selected from at least one cycloaliphatic diol, or at least one aliphatic branched short chain diol, or at least one dianhydrohexitol diol. Exemplary cycloaliphatic diols include, but are not limited to, 2,2′-(cyclohexane-1,1-diyl)-diethanol, 4,4′-bicyclohexanol, 2,2,4,4-tetramethyl-1,3-cyclobutanediol, cyclopentanediol, 1,4-cyclohexanediol, 1,4-cyclohexanedimethanol (CHDM), 1,2-cyclohexanedimethanol, 1,3-cyclohexanedimethanol, 1,3-cyclododecanediol, 1,4-cyclododecanediol, 1,5-cyclododecanediol, 1,6-cyclododecanediol, 4,4′-isopropylidenedicyclohexanol, 1-(3-hydroxypropyl)cyclohexanol, 2-(3-hydroxypropyl)cyclohexanol, 1,4-cyclohexanediethanol, 1,4-cyclohexanediethanol, 1,2-bis(hydroxymethyl)-cyclohexane, 1,2-bis(hydroxyethyl)-cyclohexane, 4,4′-isopropylidene-biscyclohexanol, bis(4-hydroxycyclohexyl) methane, and mixtures thereof.

By aliphatic branched short chain diol is meant that the diol contains an aliphatic main chain of not more than 8 carbon atoms and having at least one aliphatic side chain (or branch substituent) of at least one carbon atom. The aliphatic side chain can be linear or branched. In one aspect, the aliphatic main chain contains 3 to 8 carbon atoms and the aliphatic side chain(s) is an alkyl group containing 1 to 5 carbon atoms. As is well-known in chemical nomenclature conventions, the main chain contains a greater number of carbon atoms than the side or branch chain. Exemplary aliphatic branched short chain diols include, but not limited to, neopentyl glycol, tripropylene glycol, e.g., [(1-methyl-1,2-ethanediyl)bis(oxy)]bispropanol, 3,3-dimethoxy-1,5-pentanediol, 2-methyl-butanediol, 2,2,4-trimethyl-1,3-pentanediol, 2-methyl-1,3-pentanediol, 2-ethyl-1,3-hexanediol, 2-methyl-1,3-propanediol, 2,2-dimethyl-1,3-propanediol, dibutyl 1,3-propanediol, 2-ethyl-1,3-hexane diol, 2-butyl-2-ethyl-1,3-propanediol, 1,4-cyclohexane di-methanol, 2,4-diethyl-1,5-pentanediol, 3-methyl-1,5-pentanediol, 2-ethyl-1-methyl-1,5-pentanediol, 3-tert-butyl-1,5-pentanediol, 2-methyl-2,4-pentanediol, 2,2-diethyl-1,3-propanediol, 2,2,4-trimethyl-1,3-pentanediol, 2,2-dibutyl-1,3-propanediol, 2,2-methyl-2,3-pentanediol, 3,3-dimethyl-1,2-butanediol, 3-ethyl-1,3-pentanediol, 2-butyl-1,3-propanediol, 2-butyl-2-ethyl-1,3-propanediol, and mixtures thereof. In particular, the aliphatic branched short chain diol can be 2-methyl-1,3-propanediol. In particular, the aliphatic branched short chain diol can be 2-butyl-2-ethyl-1,3-propanediol.

Exemplary dianhydrohexitol diols include isosorbide (1,4:3,6-dianhydro-D-glucidol), isoidide (1,4:3,6-dianhydro-L-iditol), isomannide (1,4:3,6-dianhydro-D-mannitol), and mixtures thereof.

In one aspect, the chain extender component comprises a first chain extender selected from at least one linear, unsubstituted alkane diol containing from about 2 to about 20 carbon atoms, and a second chain extender selected from at least one cycloaliphatic diol. In particular, the first chain extender can be 1,4-butanediol (BDO) and the second chain extender can be 1,3-cyclohexanedimethanol (CHDM).

In one embodiment, the first chain extender can be 1,4-butanediol (BDO) and the second chain extender can be an aliphatic branched short chain diol. Particularly, the first chain extender can be 1,4-butanediol and the second chain extender component can be 2-methyl-1,3-propanedio. Particularly, the first chain extender component can be 1,4-butanediol and the second chain extender component can be 2-butyl-2-ethyl-1,3-propanediol.

The disclosed technology further provides an article made with the TPU materials and/or compositions described herein. The specific type of article or product that may be made from the TPU materials and/or compositions of the disclosed technology are not limited, if the properties of the TPU meet the specifications required by the end product. In one aspect, the TPU of the disclosed technology can be used for medical applications. Non-limiting examples include pacemaker heads; angiography, angioplasty, epidural, thermal dilution, and urology catheters; catheter connectors; medical tubing; cartilage replacement, hair replacement, joint replacement, and the like, as well as used in, personal care applications, pharmaceutical applications, health care product applications, or any other number of applications. In some aspects of the disclosed technology, these articles are prepared by extruding, injection molding, or any combination thereof.

The disclosed technology is illustrated by the following examples that are merely for the purpose of illustration and are not to be regarded as limiting the scope of the technology or the way it can be practiced. Unless specifically indicated otherwise, parts and percentages are given by weight. All weights and percentages are expressed as 100 percent active material, unless specified otherwise.

### Examples 1 to 6

A series of thermoplastic polymers, including those of the disclosed technology were prepared from the components set forth in Table 1. Each of the polymers were prepared by reacting the components and then forming test samples by extrusion or molding.

TABLE 1
(67D)

| | Polyisocyanate | Polyol | CE1¹ | CE2² | CE1:CE2 |
|---|---|---|---|---|---|
| Ex. No. | (wt. %) | (wt. %) | (wt. %) | (wt. %) | (wt. ratio) |
| 1 | HDI:Prepolymer³ | 0 | BDO⁴ | CHDM⁵ | 3:1 |
| | (1:1 wt.:wt.) | | (20.12) | (6.70) | |
| | (36.59) | | | | |
| 2 | HDI:Prepolymer³ | 0 | BDO⁴ | CHDM⁵ | 1:1 |
| | (1:1 wt.:wt.) | | (14.51) | (14.51) | |
| | (35.49) | | | | |
| 3 | HDI:Prepolymer³ | 0 | BDO⁴ | CHDM⁵ | 2:1 |
| | (1:1 wt.:wt.) | | (18.35) | (9.17) | |
| | (36.24) | | | | |
| 4^{6, 7} | N/A | N/A | N/A | N/A | N/A |
| 5^{6, 8} | H12MDI⁹ | PTMEG | BDO⁴ | — | N/A |
| | (53.78) | 1000¹⁰ | (15.63) | | |
| | | (30.59) | | | |
| 6^{6, 11} | MDI¹² | PTMEG | BDO⁴ | — | N/A |
| | (50.96) | 650¹³ and | (14.04) | | |
| | | PTMEG | | | |
| | | 1400¹⁴ | | | |
| | | (3:1 wt.:wt.) | | | |
| | | (26.25:8.75) | | | |

¹First chain extender.
²Second chain extender.
³Isocyanate terminated low free prepolymer: a reaction product of hexamethylene diisocyanate (HDI) and a polyether polyol having a low free HDI content (<0.1 wt. %) (Adiprene ™ LFH E1192).
⁴BDO = 1,4-butane diol.
⁵CHDM = 1,4-cyclohexanedimethanol.
⁶Comparative example.
⁷Pebax ™ 7233—Commercially available polyether block amide marketed by Arkema.
⁸Aliphatic TPU.
⁹H12MDI = dicyclohexylmethane-4,4′-diisocyanate.
¹⁰Polytetramethylene ether glycol (1000 Mn).
¹¹Aromatic TPU.
¹²MDI = 4,4′-methylene bis-(phenyl isocyanate).
¹³Polytetramethylene ether glycol (650 Mn).
¹⁴Polytetramethylene ether glycol (1400 Mn).

### Examples 7 to 12

Each of the polymer samples prepared in Examples 1 to 6 were assessed to verify its Shore D hardness (as measured by ASTM D2240), Dry Flexural Modulus (as measured by ASTM D790), Wet Flexural Modulus (as measured by ASTM D790), and its rebound resilience (as measured by ASTM D2632), Elongation at Break (as measured by ASTM D412), Tensile Strength (as measured by ASTM D412), Rebound Resilience (as measured by ASTM D2632), and Softening Percent. Prior to running Shore D hardness (ASTM D2240) and Flexural Modulus (ASTM D790) testing, injection molded bar test samples (5 in. long×½ in. wide×⅛ in thick) were stored at room temperature for at least 5 days, followed by conditioning for 40 hours at 23+/−2° C., 50% RH+/−5%.

Softening Percent was determined by measuring the Flexural Modulus (at ambient Room Temperature (RT): 20-25° C.) according to ASTM D790 on dry injection molded bars and wetted injection molded bars (5 in. long×½ in. wide×⅛ in thick) that were soaked in deionized water for 5-days at 40° C. and entering the results into the following formula:

$$Softening \% = [ \text{} ( Flexural {Modulus}_{dry} - Flexural {Modulus}_{w e t} ) \times 100 / Flexural {Modulus}_{dry}$$

The results of all tests are presented in Table 2.

TABLE 2

| | Ex. 7 | Ex. 8 | Ex. 9 | Ex. 10¹ | Ex. 11¹ | Ex. 12¹ |
|---|---|---|---|---|---|---|
| | (Polymer | (Polymer | (Polymer | (Polymer | (Polymer | (Polymer |
| Test | Ex. 1) | Ex. 2) | Ex. 3) | Ex. 4) | Ex. 5) | Ex. 6) |
| Shore D | 65 | 66 | 66 | 67 | 67 | 74 |
| Hardness | | | | | | |
| (5 sec) | | | | | | |
| Dry | 52200 | 36584 | 46359 | 109228 | 154701 | 142062 |
| Flexural | | | | | | |
| Modulus | | | | | | |
| (psi) | | | | | | |
| Wet | 47729 | 34128 | 40039 | 57993 | 5820 | 16663 |
| Flexural | | | | | | |
| Modulus | | | | | | |
| (psi) | | | | | | |
| Softening | 9 | 7 | 14 | 47 | 96 | 88 |
| (%) | | | | | | |
| Tensile | 8137 | 7413 | 7887 | 9747 | 7973 | 10425 |
| Strength | | | | | | |
| (psi) | | | | | | |
| Elongation | 374 | 367 | 359 | 486 | 307 | 315 |
| at Break | | | | | | |
| (%) | | | | | | |
| Rebound | 45 | 46 | 45 | 37 | 30 | 35 |
| Resilience | | | | | | |
| (%) | | | | | | |

¹Comparative example.

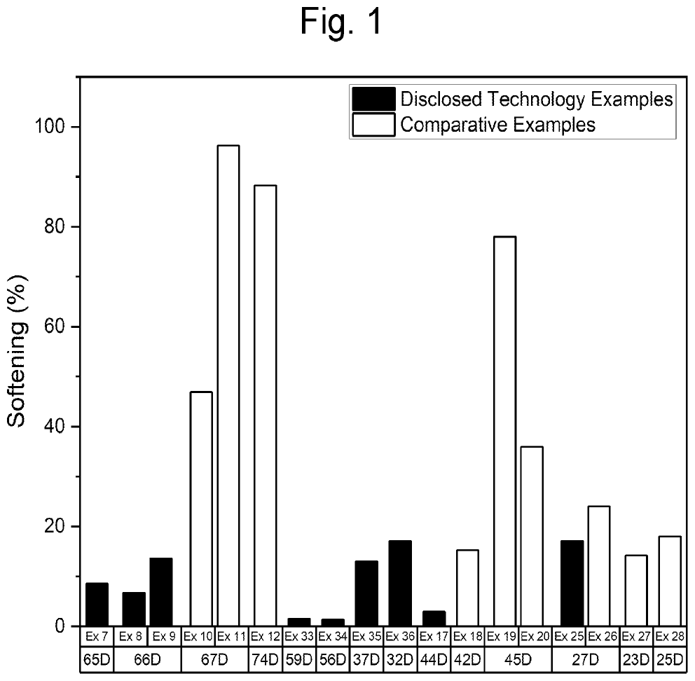

The results indicate that the TPU compositions of the disclosed technology provide superior dry flexural modulus to conventional aliphatic and aromatic TPU compositions, while all other properties were comparable. The Shore D and softening % values for the TPUs of Examples 7 to 9 of the disclosed technology are compared with the comparative polymers of Examples 10, 11 and 12, including a Pebax™ polymer benchmark and comparative aliphatic and aromatic TPUs. The softening % and Shore D values for the TPUs of Examples 7 to 12 are plotted in FIG. 1.

### Examples 13 to 16

A series of thermoplastic polymers were prepared from the components set forth in Table 3.

TABLE 3
(45D)

| Ex. | Polyisocyanate | Polyol | CE1¹ | CE2² | CE1:CE2 |
|---|---|---|---|---|---|
| No. | (wt. %) | (wt. %) | (wt. %) | (wt. %) | (wt. ratio) |
| 13 | HDI:Prepolymer³ | PTMEG⁴ | BDO⁵ | CHDM⁶ | 3:1 |
| | (1:2 wt.:wt.) | 2000 | (10.61) | (3.54) | |
| | (17.95:35.90) | (32.00) | | | |
| 14^{7, 8} | N/A | N/A | N/A | N/A | N/A |
| 15^{7, 9} | H12MDI¹⁰ | PTMEG¹¹ | BDO⁵ | — | N/A |
| | (45.02) | 1000 | (11.45) | | |
| | | (43.53) | | | |
| 16^{7, 12} | MDI¹³ | PTMEG¹¹ | BDO⁵ | — | N/A |
| | (38.86) | 1000 | (9.21) | | |
| | | (51.93) | | | |

¹First chain extender.
²Second chain extender.
³Isocyanate terminated low free prepolymer: a reaction product of hexamethylene diisocyanate (HDI) and a polyether polyol having a low free HDI content (<0.1 wt. %) (Adiprene ™ LFH E1192).
⁴Polytetramethylene ether glycol (2000 Mn)
⁵BDO = 1,4-butane diol.
⁶CHDM = 1,4-cyclohexanedimethanol.
⁷Comparative example.
⁸Pebax ™ 4033—Commercially available polyether block amide marketed by Arkema.
⁹Aliphatic TPU
¹⁰H12MDI = dicyclohexylmethane-4,4′-diisocyanate.
¹¹Polytetramethylene ether glycol (1000 Mn)
¹²Aromatic TPU
¹³MDI = 4,4′-methylene bis-(phenyl isocyanate).

### Examples 17 to 20

Each of the polymer samples prepared in Examples 13 to 16 was accessed to verify the following properties: Shore D hardness, Dry Flexural Modulus, Wet Flexural Modulus, Rebound Resilience, Elongation at Break, Tensile Strength, Rebound Resilience, and Softening Percent, utilizing the test protocols set forth in Examples 7 to 12. The results are presented in Table 4.

TABLE 4

| | Ex. 17 | Ex. 18¹ | Ex. 19¹ | Ex. 20¹ |
|---|---|---|---|---|
| | (Polymer | (Polymer | (Polymer | (Polymer |
| Test | Ex. 13) | Ex. 14) | Ex. 15) | Ex. 16) |
| Shore D | 44 | 42 | 45 | 45 |
| Hardness | | | | |
| (5 sec) | | | | |
| Dry | 15481 | 12610 | 15568 | 8944 |
| Flexural | | | | |
| Modulus | | | | |
| (psi) | | | | |
| Wet | 15025 | 10060 | 3421 | 5727 |
| Flexural | | | | |
| Modulus | | | | |
| (psi) | | | | |
| Softening | 3 | 20 | 78 | 36 |
| (%) | | | | |
| Tensile | 8259 | 6738 | 10029 | 8488 |
| Strength | | | | |
| (psi) | | | | |
| Elongation | 564 | 794 | 413 | 419 |
| at Break | | | | |
| (%) | | | | |
| Rebound | 42 | 39 | 31 | 30 |
| Resilience | | | | |
| (%) | | | | |

¹Comparative example.

The results indicate that the TPU compositions of the disclosed technology provide superior non-softening properties relative to the commercial benchmark Pebax™ polyether block amide polymer and conventional aliphatic and aromatic TPU compositions, while all other measured properties were comparable. The softening percent and Shore D values for these examples are plotted in FIG. 1.

### Examples 21 to 24

A series of thermoplastic polymers were prepared from the components set forth in Table 5.

TABLE 5
(25D)

| Ex. | Polyisocyanate | Polyol | CE1¹ | CE2² | CE1:CE2 |
|---|---|---|---|---|---|
| No. | (wt. %) | (wt. %) | (wt. %) | (wt. %) | (wt. ratio) |
| 21 | HDI:Prepolymer³ | PTMEG³ | BDO⁵ | CHDM⁶ | 3:1 |
| | (1:2 wt.:wt.) | 2000 | (3.06) | (1.02) | |
| | (8.64:17.28) | (70.00) | | | |
| 22^{7, 8} | N/A | N/A | N/A | N/A | N/A |
| 23^{7, 9} | H12MDI¹⁰ | PTMEG³ | BDO⁵ | — | N/A |
| | (21.17) | 2000 | (3.98) | | |
| | | (74.85) | | | |
| 24^{7, 12} | MDI¹³ | PTMEG¹¹ | BDO⁵ | — | N/A |
| | (28.54) | 1000 | (3.98) | | |
| | | (67.48) | | | |

¹First chain extender.
²Second chain extender.
³Isocyanate terminated low free prepolymer: a reaction product of hexamethylene diisocyanate (HDI) and a polyether polyol having a low free HDI content (<0.1 wt. %) (Adiprene ™ LFH E1192).
⁴Polytetramethylene ether glycol (2000 Mn)
⁵BDO = 1,4-butane diol.
⁶CHDM = 1,4-cyclohexanedimethanol.
⁷Comparative example.
⁸Pebax ™ 2533—Commercially available polyether block amide marketed by Arkema.
⁹Aliphatic TPU
¹⁰H12MDI = dicyclohexylmethane-4,4′-diisocyanate.
¹¹Polytetramethylene ether glycol (1000 Mn)
¹²Aromatic TPU
¹³MDI = 4,4′-methylene bis-(phenyl isocyanate).

### Examples 25 to 28

Each of the polymer samples prepared in Examples 21 to 24 was accessed to verify the following properties: Shore D hardness, Dry Flexural Modulus, Wet Flexural Modulus, Rebound Resilience, Elongation at Break, Tensile Strength, Rebound Resilience, and Softening Percent, utilizing the test protocols set forth in Examples 7 to 12. The results are presented in Table 6.

TABLE 6

| | Ex. 25 | Ex. 26¹ | Ex. 27¹ | Ex. 28¹ |
|---|---|---|---|---|
| | (Polymer | (Polymer | (Polymer | (Polymer |
| Test | Ex. 21) | Ex. 22) | Ex. 23) | Ex. 24) |
| Shore D | 27 | 27 | 23 | 25 |
| Hardness | | | | |
| (5 sec) | | | | |
| Dry | 4186 | 2644 | 972 | 1767 |
| Flexural | | | | |
| Modulus | | | | |
| (psi) | | | | |
| Wet | 3469 | 2009 | 834 | 1449 |
| Flexural | | | | |
| Modulus | | | | |
| (psi) | | | | |
| Softening | 17 | 24 | 14 | 18 |
| (%) | | | | |
| Tensile | 6099 | 4287 | 5996 | 5316 |
| Strength | | | | |
| (psi) | | | | |
| Elongation | 739 | 971 | 724 | 583 |
| at Break | | | | |
| (%) | | | | |
| Rebound | 63 | 45 | 51 | 44 |
| Resilience | | | | |
| (%) | | | | |

¹Comparative example.

The results illustrate that the TPU of the disclosed technology (Example 25) provides at least comparable, and in some cases a combination of superior properties relative to the commercial benchmark Pebax™ comparative example and conventional aliphatic and aromatic TPU comparative examples, where all the samples have a similar hardness. It is noted that the TPU of Example 25 has a softening %, tensile strength and rebound recovery properties superior to the commercial benchmark of Example 26, while the comparative TPUs (Examples 27 and 28) loose one one or more of other physical properties. For example, even though softening % of the TPUs of Examples 27 and 28 is comparable to the TPU of the disclosed technology, the tensile and rebound properties of these comparison TPUs are significantly lower which will have an adverse impact on medical device performance. The softening percent and Shore D values of these Examples are plotted in FIG. 1.

### Examples 29 to 32

A series of thermoplastic polymers were prepared from the components set forth in Table 7.

TABLE 7
(30D to 60D)

| | Polyisocyanate | Polyol | CE11 | CE22 | CE1:CE2 |
|---|---|---|---|---|---|
| Ex. No. | (wt. %) | (wt. %) | (wt. %) | (wt. %) | (wt. ratio) |
| 29 | HDI:Prepolymer³ | PTMEG⁴ | BDO⁵ | CHDM⁶ | 3:1 |
| | (1:2 wt.:wt.) | 2000 | (15.95) | (5.32) | |
| | (24.58%:49.15%) | (5.00) | | | |
| 30 | HDI:Prepolymer³ | PTMEG⁴ | BDO⁵ | CHDM⁷ | 3:1 |
| | (1:2 wt.:wt.) | 2000 | (15.16) | (5.05) | |
| | (23.60:47.19) | (9.00) | | | |
| 31 | HDI:Prepolymer³ | PTMEG⁴ | BDO⁵ | CHDM⁶ | 3:1 |
| | (1:2 wt.:wt.) | 2000 | (8.22) | (2.74) | |
| | (15.01:30.03) | (44.00) | | | |
| 32 | HDI:Prepolymer³ | PTMEG⁴ | BDO⁵ | CHDM⁶ | 3:1 |
| | (1:2 wt.:wt.) | 2000 | (5.05) | (1.68) | |
| | (11.09:22.18) | (60.00) | | | |

¹First chain extender.
²Second chain extender.
³Isocyanate terminated low free prepolymer: a reaction product of hexamethylene diisocyanate (HDI) and a polyether polyol having a low free HDI content (<0.1 wt. %) (Adiprene ™ LFH E1192).
⁴Polytetramethylene ether glycol (2000 Mn)
⁵BDO = 1,4-butane diol.
⁶CHDM = 1,4-cyclohexanedimethanol.

### Examples 33 to 36

Each of the polymer samples prepared in Examples 29 to 32 was accessed to verify the following properties: Shore D hardness, Dry Flexural Modulus, Wet Flexural Modulus, Rebound Resilience, Elongation at Break, Tensile Strength, Rebound Resilience, and Softening Percent, utilizing the test protocols set forth in Examples 7 to 12. The results are presented in Table 8.

TABLE 8

| | Ex. 33 | Ex. 34 | Ex. 35 | Ex. 36 |
|---|---|---|---|---|
| | (Polymer | (Polymer | (Polymer | (Polymer |
| Test | Ex. 29) | Ex. 30) | Ex. 31) | Ex. 32) |
| Shore D | 59 | 56 | 37 | 32 |
| Hardness | | | | |
| (5 sec) | | | | |
| Dry | 39100 | 36613 | 10071 | 5743 |
| Flexural | | | | |
| Modulus | | | | |
| (psi) | | | | |
| Wet | 38503 | 36110 | 9698 | 4995 |
| Flexural | | | | |
| Modulus | | | | |
| (psi) | | | | |
| Softening | 2 | 1 | 4 | 13 |
| (%) | | | | |
| Tensile | 10379 | 7699 | 6164 | 5841 |
| Strength | | | | |
| (psi) | | | | |
| Elongation | 492 | 440 | 600 | 679 |
| at Break | | | | |
| (%) | | | | |
| Rebound | 42 | 45 | 42 | 54 |
| Resilience | | | | |
| (%) | | | | |

The polymers of Examples 33 to 36 exhibited softening percentages significantly below 20% while maintaining good tensile strength, dry flexural modulus, dry flexural modulus, elongation at break and rebound resilience properties. The softening percent and Shore D values of these Examples are plotted in FIG. 1.

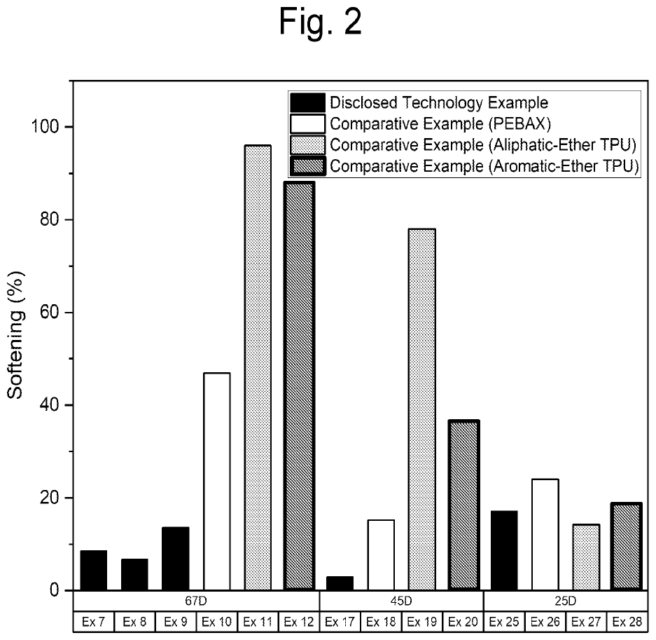

The Shore D durometer values versus softening % properties for the polymers of the examples set forth in Tables 2, 4, and 6, show a direct correlation between hardness and non-softening characteristics. As the hardness increases (Shore D durometer values), the degree of softening in the polymer increases. On the other hand, the hardness, and non-softening characteristics of the TPUs of the disclosed technology are decoupled, i.e., the degree of softening is independent of the hardness of the TPU. The relationship between Shore D durometer hardness values versus softening % is illustrated in FIG. 2.

### Example 37

A thermoplastic polymer was prepared from the components set forth in Table 9

TABLE 9

| Ex. | Polyisocyanate | Polyol | CE1¹ | CE2² | CE1:CE2 |
|---|---|---|---|---|---|
| No. | (wt. %) | (wt. %) | (wt. %) | (wt. %) | (wt. ratio) |
| 37 | HDI:Prepolymer³ | 0 | BDO⁴(18.81) | BEPD | 2:1 |
| | (1:1 wt.:wt.) | | | (9.41)⁵ | |
| | (35.64) | | | | |

¹First chain extender.
²Second chain extender.
³Isocyanate terminated low free prepolymer: a reaction product of hexamethylene diisocyanate (HDI) and a polyether polyol having a low free HDI content (<0.1 wt. %) (Adiprene ™ LFH E1192).
⁴BDO = 1,4-butane diol.
⁵BEPD = 2-butyl-2-ethyl-1,3-propanediol

The polymer of Example 37 was tested to verify the following properties: Shore D hardness, Dry Flexural Modulus, Wet Flexural Modulus, Rebound Resilience, Softening, Tensile at break and elongation at break, and utilizing the test protocols set forth above. The results are presented in Table 10.

TABLE 10

| Test | Polymer Ex. 37 |
|---|---|
| Durometer | 61D |
| Ambient Dry Flexural Modulus (psi) | 39129 |
| Wet Flex Modulus (psi)¹ | 36095 |
| Softening (%) | 8% |
| Tensile at break (psi) | 7099 |
| Elongation at Break (%) | 374 |

¹Wet flexural modulus determined at 40° C.

The results demonstrate that Example 37 shows low softening values.

1. A thermoplastic polyurethane prepared from a reaction mixture comprising:
(a) at least one isocyanate terminated low free polyurethane prepolymer composition prepared from the reaction of at least one polyisocyanate component (i) and at least one polyol component (ii), wherein said low free polyurethane prepolymer composition comprises more than about 0 wt. % to about 1 wt. % or less of residual polyisocyanate component, based on the total weight of the low free polyurethane prepolymer, wherein the amount of said low free polyurethane prepolymer ranges from about 1 to about 80 wt. % based on the total weight of said thermoplastic polyurethane;
(b) at least one linear aliphatic polyisocyanate, wherein the weight ratio of said at least one aliphatic polyisocyanate to said low free polyurethane prepolymer ranges from about 10:1 to about 1:10.
(c) at least one polyol component ranging from 0 wt. % to about 80 wt. % of the total weight of the thermoplastic polyurethane; and
(d) a chain extender component comprising (iii) a first chain extender comprising at least one linear, unsubstituted alkane diol containing from about 2 to about 20 carbon atoms, and (iv) a second chain extender selected from the group consisting of at least one cycloaliphatic diol, at least one aliphatic branched short chain diol, and at least one dianhydrohexitol diol, wherein the weight ratio of said first chain extender to said second chain extender ranges from about 1:19 to about 19:1.

2. A thermoplastic polyurethane of claim 1, wherein the isocyanate content of the at least one isocyanate terminated low free polyurethane prepolymer is from about 0.2 to about 15 wt. % based on the total weight of the at least one isocyanate terminated low free polyurethane prepolymer.

3. A thermoplastic polyurethane of claim 1, wherein the at least one isocyanate terminated low free polyurethane prepolymer comprises less than about 75 wt. % of a 2:1 stoichiometric adduct of the at least one polyisocyanate (i) and the at least one polyol component (ii), based on the total weight of the low free polyurethane prepolymer.

4. A thermoplastic polyurethane of claim 1, wherein said at least one isocyanate terminated low free polyurethane prepolymer (a) is prepared from at least one polyisocyanate component (i) selected from the group consisting of 4,4′-methylene bis-(phenyl isocyanate) (MDI); m-xylylene diisocyanate (XDI), phenylene-1,4-diisocyanate (PPDI), 3,3′-dimethyl-4,4′-biphenylene diisocyanate (TODI), diphenylmethane-3,3′-dimethoxy-4,4′-diisocyanate, toluene diisocyanate (TDI), and naphthalene-1,5-diisocyanate, isophorone diisocyanate (IPDI), dicyclohexylmethane-4,4′-diisocyanate (H12MDI), 1,4-cyclohexyl diisocyanate (CHDI), 1,6-hexamethylene diisocyanate (HDI), decane-1,10-diisocyanate; and mixtures thereof.

5. A thermoplastic polyurethane of claim 1, wherein said at least one isocyanate terminated low free polyurethane prepolymer (a) is prepared from at least one polyol component (ii) selected from the group consisting of a polyether polyol, a polyester polyol, a polycarbonate polyol, a polysiloxane polyol, an alkoxylated polysiloxane polyol, a polybutadiene polyol, and combinations thereof.

6. A thermoplastic polyurethane of claim 1, wherein said at least one isocyanate terminated low free polyurethane prepolymer (a) is prepared from a polyol (ii) selected from at least one polyether polyol selected from the group consisting of poly(ethylene oxide), polyethylene glycol, poly(propylene oxide), polypropylene glycol, and polytetramethylene ether glycol.

7. A thermoplastic polyurethane of claim 1, wherein said at least one isocyanate terminated low free polyurethane prepolymer (a) is prepared by the reaction of 1,6-hexamethylene diisocyanate with polytetramethylene ether glycol.

8. A thermoplastic polyurethane of claim 5, wherein said at least one isocyanate terminated low free polyurethane prepolymer (a) is terminated with an isocyanatohexyl group.

9. A thermoplastic polyurethane of claim 6, wherein said at least one isocyanate terminated low free polyurethane prepolymer (a) contains more than about 0 wt. % to about 0.5 wt. % or less of residual 1,6-hexamethylene diisocyanate.

10. A thermoplastic polyurethane of claim 1, wherein said at least one isocyanate terminated low free polyurethane prepolymer (a) comprises less than about 80 wt. % of a 2:1 stoichiometric adduct of said at least one polyisocyanate component (i) and said at least one polyol component (ii).

11. A thermoplastic polyurethane of claim 1, wherein said at least one linear aliphatic polyisocyanate component (b) is 1,6-hexamethylene diisocyanate.

12. A thermoplastic polyurethane of claim 1, wherein said at least one polyol component (c) is selected from the group consisting of a polyether polyol, a polyester polyol, a polycarbonate polyol, a polysiloxane polyol, and a polybutadiene polyol.

13. A thermoplastic polyurethane of claim 1, wherein said at least one polyol component (c) is a polyether polyol selected from the group consisting of poly(ethylene oxide), polyethylene glycol, poly(propylene oxide), polypropylene glycol, and polytetramethylene ether glycol.

14. A thermoplastic polyurethane of claim 1, wherein said polyether polyol component (c) has a number average molecular weight ranging from about 300 to about 3000.

15. A thermoplastic polyurethane of claim 1, wherein said polyether polyol component (c) is polytetramethylene ether glycol.

16. A thermoplastic polyurethane of claim 1, wherein said first linear, unsubstituted alkane diol chain extender (d)(iii) is selected from the group consisting of ethylene glycol, diethylene glycol, propylene glycol, 1,3-propane diol, dipropylene glycol, 1,3-butanediol, 1,4-butanediol (BDO), 1,5-pentanediol, 1,6-hexanediol (HDO), 1,7-heptanediol, 1,9-nonanediol, 1,11-undecanediol, and 1,12-dodecanediol.

17. A thermoplastic polyurethane of claim 1, wherein said second chain extender component (d)(iv) is a cycloaliphatic diol selected from the group consisting of 2,2′-(cyclohexane-1,1-diyl)-diethanol, 4,4′-bicyclohexanol, 2,2,4,4-tetramethyl-1,3-cyclobutanediol, cyclopentanediol, 1,4-cyclohexanediol, 1,4-cyclohexanedimethanol, 1,2-cyclohexanedimethanol, 1,3-cyclohexanedimethanol, 1,3-cyclododecanediol, 1,4-cyclododecanediol, 1,5-cyclododecanediol, 1,6-cyclododecanediol, 4,4′-isopropylidenedicyclohexanol, 1-(3-hydroxypropyl)cyclohexanol, 2-(3-hydroxypropyl)cyclohexanol, 1,4-cyclohexanediethanol, 1,4-cyclohexanediethanol, 1,2-bis(hydroxymethyl)-cyclohexane, 1,2-bis(hydroxyethyl)-cyclohexane, 4,4′-isopropylidene-biscyclohexanol, bis(4-hydroxycyclohexyl) methane, and mixtures thereof.

18. A thermoplastic polyurethane of claim 1, wherein said second chain extender component (d)(iv) is an aliphatic branched short chain diol selected from the group consisting of neopentyl glycol, tripropylene glycol, 3,3-dimethoxy-1,5-pentanediol, 2-methyl-butanediol, 2,2,4-trimethyl-1,3-pentanediol, 2-methyl-1,3-pentanediol, 2-ethyl-1,3-hexanediol, 2-methyl-1,3-propanediol, 2,2-dimethyl-1,3-propanediol, dibutyl 1,3-propanediol, 2-ethyl-1,3-hexane diol, 2-butyl-2-ethyl-1,3-propanediol, 2,4-diethyl-1,5-pentanediol, 3-methyl-1,5-pentanediol, 2-ethyl-1-methyl-1,5-pentanediol, 3-tert-butyl-1,5-pentanediol, 2-methyl-2,4-pentanediol, 2,2-diethyl-1,3-propanediol, 2,2,4-trimethyl-1,3-pentanediol, 2,2-dibutyl-1,3-propanediol, 2,2-methyl-2,3-pentanediol, 3,3-dimethyl-1,2-butanediol, 3-ethyl-1,3-pentanediol, 2-butyl-1,3-propanediol, 2-butyl-2-ethyl-1,3-propanediol, and mixtures thereof.

19. A thermoplastic polyurethane of claim 1, wherein said second chain extender component (d)(iv) is a dianhydrohexitol diol selected from the group consisting of isosorbide, isoidide, isomannide, and mixtures thereof.

20. A thermoplastic polyurethane of claim 1, wherein said first chain extender component is 1,4-butanediol and said second chain extender component is 1,4-cyclohexanedimethanol.

21. A thermoplastic polyurethane of claim 1, wherein said first chain extender component is 1,4-butanediol and said second chain extender component is 2-methyl-1,3-propanediol or wherein said first chain extender component is 1,4-butanediol and said second chain extender component is 2-butyl-2-ethyl-1,3-propanediol.

22. A thermoplastic polyurethane of claim 1, wherein the weight ratio of the polyol component to total chain extender component (first and second) ranges from about 0 to about 20:1.

23. The thermoplastic polyurethane of claim 1, wherein the chain extender component comprises from 2 wt. % to 35 wt. % of the total weight of the polyurethane.

24. A thermoplastic polyurethane of claim 1, having one or more of the following properties:
a) Shore D hardness, as measured by ASTM D2240, from about 20 to about 75;
b) a dry flexural modulus, as measured by ASTM D790, from about 4,000 to about 90,000 psi;
c) a wet flexural modulus, as measured by ASTM D790, from about 3,000 to about 50,000 psi;
d) an elongation at break, as measured by ASTM D412 from about 300 to about 750 percent;
e) a tensile strength, as measured by ASTM D412, of from about 5,000 to about 10,000 psi;
f) a rebound recovery as measured by ASTM D2632 of from about 40 to about 65 percent.

25. A thermoplastic polyurethane of claim 1 having a softening % of 20 or less.

26. (canceled)

27. An article comprising the thermoplastic polyurethane of claim 1, wherein the article is selected from the group consisting of a pacemaker head, an angiography catheter, an angioplasty catheter, an epidural catheter, a thermal dilution catheter, a urology catheter, a catheter connector, medical tubing, a cartilage replacement, or and a joint replacement.

28. (canceled)
